(19) United States
(12) Patent Application Publication
(10) Pub. No.: US 2013/0094660 A1
(43) Pub. Date: Apr. 18, 2013

(54) HANDS-FREE MOBILE AUDIO DEVICE FOR WIRELESSLY CONNECTING AN ELECTRONIC DEVICE WITH HEADPHONES FOR TRANSMITTING AUDIO SIGNALS THERETHROUGH

(71) Applicants: Nathan Daniel Weinstein, Glastonbury, CT (US); Garold C. Miller, Glastonbury, CT (US)

(72) Inventors: Nathan Daniel Weinstein, Glastonbury, CT (US); Garold C. Miller, Glastonbury, CT (US)

(73) Assignee: Halo2Cloud LLC, Glastonbury, CT (US)

(21) Appl. No.: 13/646,172

(22) Filed: Oct. 5, 2012

Related U.S. Application Data
(60) Provisional application No. 61/552,151, filed on Oct. 27, 2011.
(60) Provisional application No. 61/544,759, filed on Oct. 7, 2011.

(51) Int. Cl. H04R 1/10

(52) U.S. Cl. CPC H04R 1/10
USPC 381/74

(57) ABSTRACT

A wireless hands-free mobile audio device is provided for wirelessly connecting an electronic device with at least one headphone speaker for transmitting audio signals therethrough, essentially transforming any set of headphones into a wireless headset. The mobile audio device comprises a housing having a wireless interface for connecting with the electronic device, and an audio output port for transmitting audio signals received by the mobile audio device from the electronic device to at least one earpiece or speaker connected thereto. The mobile audio device can also include a pre-attached earpiece component in addition to the separate audio output port permitting use of the device either by attaching a standard set of headphone to the housing or attaching a singular earpiece for use with the pre-attached earpiece component where audio signals are simultaneously transmitted to the pre-attached earpiece and the audio output port.

### CROSS REFERENCE TO RELATED APPLICATIONS

The present application claims the benefit under 35 U.S.C. § 119(e) of U.S. Provisional Application No. 61/552,151, filed Oct. 27, 2011, and of U.S. Provisional Application No. 61/544,759, filed Oct. 7, 2011, both of which provisional applications are incorporated herein by reference.

### TECHNICAL FIELD

The present invention generally relates to mobile devices for transmitting audio signals, and more particularly to mobile devices for connecting headphones with an electronic device via a wireless network for transmitting audio signals through the headphones.

### BACKGROUND OF THE INVENTION

Personal computers and held electronic devices, such as cellular telephones, smart phones, tablets, and media players, have become a familiar convenience due to ease of use, portability, and increased functionality and connectivity for a variety of uses, including making phone calls, sending text messages and emails, listening to music, watching videos, social networking, and connecting to the Internet. Yet in many situations, handheld use of such devices can render the device inconvenient. For example, most States now ban handheld use of a mobile phone while driving. As another example, many customer-oriented establishments have established policies to refuse service to patrons clearly speaking on a mobile phone while interacting with staff. More pragmatically, it is exceedingly difficult to perform other tasks, or carry other objects while also holding and using an electronic device—for example, holding a handset to one's ear, or carrying a music player while listening to music.

Accordingly, hands-free devices have been developed to enable continued use of electronic devices despite inconvenient rules or circumstances. These hands-free devices can broadly be categorized as “headphones” or “earpieces,” which generally include integral speakers and microphones, but commonly include a long electrical cord that tethers the user to the electronic device transmitting audio signals to the headphones via an output jack on the electronic device. Thus, if the user is moving, for example, by walking, the user must still carry the electronic device while wearing the headphones, thereby obviating the “hands-free” aspect of the headphones.

Wireless earpieces have been developed to facilitate hands-free operation of mobile phones. For example, a user can communicate on the phone via the wireless earpiece even if the phone is in the user's pocket or bag. Such wireless earpieces have increased flexibility of use of a mobile phone in a hands- free fashion. However, such wireless earpieces typically only operate with mobile phones, and even then, only phones to which they can be synced, and do not provide functionality of use with other electronic devices, such as computers, tablets, and portable music players. Moreover, such wireless earpieces do not permit wireless operation with multiple devices at the same time, usually permitting the earpiece to be paired with only one device at a time. Thus, if a user desires to use multiple devices at the same time—e.g., a mobile phone and a portable music player—the user will need to use different speaker devices—e.g., a wireless earpiece for the mobile phone and a set of headphones for the music player—and switch between such speaker devices as necessary in order to take a call or listen to a song.

Known hands-free devices present additional difficulties. For example, devices physically connected to phones by electrical cords can have the cords get tangled around clothing, bags, seat belts, door handles, chair armrests, and the like. Additionally, earpieces specifically designed for telecommunications are not always suitable for listening to music. Indeed, some earpieces that include ear buds placed into the ear are often uncomfortable for long periods of use. Moreover, wireless headphones adapted for use with music players or computers are often not capable of or compatible for wireless transmission of audio signals (such as, via a mobile phone). For example, such headphones are only capable of receiving audio signals, and do not include a microphone for sending audio signals from the user to an electronic device, such as a mobile phone.

In view of the foregoing, there is a need for a mobile audio device that can be used to connect headphones with an electronic device via a wireless network for transmitting audio signals through the headphones for hands-free operation of the electronic device. Additionally, there is a need for using such wireless headphones to both receive audio signals but also transmit audio signals to an electronic device via a microphone included with the mobile audio device. Still further, the is a need for transforming existing headphones into wireless headphones capable of exchanging audio signals with an electronic device without needing to be directly connected to the electronic device by an electrical cord. Still further, there is a need for a mobile device providing hands-free use of headphones in connection with multiple different electronic devices at the same time. Accordingly, it is a general object of the present invention to provide a mobile audio device for transmitting audio signals to a user via headphones that improves upon headphones, earpieces, speakers and other hands-free devices currently on the market and that overcomes the problems and drawbacks associated with such prior art hands-free devices.

### SUMMARY OF THE INVENTION

In accordance with the present invention, a wireless hands-free mobile audio device is provided for wirelessly connecting an electronic device with at least one headphone speaker for transmitting audio signals therethrough. In general, a mobile audio device is provided for connecting headphones, comprising at least one earpiece or speaker, with an electronic device via a wireless network for transmitting audio signals generated by the electronic device to the user via the headphones. In this regard, the mobile audio device can transform any set of headphones into a wireless headset, including standard headphones that lack wireless or Bluetooth® transmission capabilities. Accordingly, the mobile audio device of the present invention addresses a significant drawback of standard headphones by eliminating the need to tether oneself to an electronic device during use with headphones.

In a first aspect of the present invention, the mobile audio device comprises a housing having an audio output port for transmitting audio signals received by the mobile audio device from the electronic device to at least one earpiece or speaker connected thereto. The mobile audio device also includes a wireless interface for connecting with at least one electronic device for transmission of audio signals form the electronic device to the mobile audio device.

The audio output port, such as an audio jack, can receive an input interface from a separate earpiece component, such as headphones. Alternately or additionally, the audio output port may be directly connected to an earpiece attached to and included with the mobile audio device. Thus, in one embodiment of the present invention, the housing is provided with an output port for attaching separate headphones, permitting use of standard headphones. In another embodiment, the housing includes an earpiece pre-attached thereto, permitting at least monophonic use of the preexisting earpiece for receiving, for example, a phone call. In still another embodiment, the mobile audio device can include a pre-attached earpiece component as well as a separate audio output port permitting stereo use of the device—e.g., to listen to music—either by attaching a standard set of headphone to the housing or attaching a singular earpiece for use with the pre-attached earpiece component where audio signals are simultaneously transmitted to the pre-attached earpiece and the audio output port.

In another aspect of the present invention, the mobile audio device comprises a housing with a wireless interface for connecting with at least one electronic device for transmission of audio signals form the electronic device to the mobile audio device. The device also includes a first earpiece mechanically and operatively attached to the housing permitting at least monophonic use of the mobile audio device to transmit audio signals received by the mobile audio device from an electronic device with which it is connected via the wireless interface to a speaker provided in the earpiece. The device further includes an audio output port provided on the housing for transmitting the audio signals received by the mobile audio device from the electronic device to at least one separate earpiece connected thereto and permitting stereophonic use of the mobile audio device when the separate second earpiece is connected with the audio output port and used simultaneously with the attached first earpiece.

In embodiments of the present invention, the audio output port can be used independently of the attached first earpiece when a separate second earpiece having at least one speaker is connected to the mobile audio device via the output port. Further, audio signals transmitted to the attached first earpiece can be turned off without effecting the transmission of signals to the audio output port.

In still another aspect of the present invention, the mobile audio device includes a microphone for receiving audio signals from a user. In this regard, the mobile audio device permits a user to communicate with an electronic device, such as a mobile phone, using the microphone to send audio signals, and the headphones either included with the device or attached thereto, to receive audio signals. Additionally, the mobile audio device permits the user to switch between multiple electronic devices paired therewith for receiving and sending audio signals and continue using the same headphones regardless of which electronic device is wirelessly connected to or paired with the mobile audio device.

In still another aspect of the present invention, the mobile audio device transforms any set of headphones into a wireless hands-free device that is easily connectable to multiple electronic devices and less obtrusive than if the same headphones were directly connected and tethered to such electronic devices.

In some embodiments of the present invention, the pre-attached earpiece component may be mechanically and operatively connected with the device housing by way of a retractable cord that electrically connects the earpiece component to the housing and its internal electronic components and circuitry, such as an audio processor. Further, the audio signals transmitted to the pre-attached earpiece can be turned off when the cord is retracted within the device housing to position an earbud of the earpiece at a predefined position relative to the housing, for example, as determined by a sensor.

The device housing may also be provided with a fastener, such as a spring clip and more preferably a rotatable clip, a lanyard, a magnet, and the like, for securing the mobile audio device in place for use, for example, by attaching the device to a user's clothes, bag or briefcase, while allowing the user to control the positioning of the device for the most convenient and comfortable use of headphones provided with or attached to the device housing. For example, the user can attach and align the device in a position where the cord from the attached headphones or the retractable cord from the pre-attached earpiece component extending from the device housing will not interfere with the user during use of the electronic device wireless communicating with the mobile audio device, regardless of the user's activity. Further, the microphone on the mobile audio device can be aligned for optimal use when the user uses the mobile audio device for a phone call.

These and other objects, features and advantages of the present invention will become apparent in light of the detailed description of the best mode embodiment thereof, as illustrated in the accompanying drawings, wherein

### BRIEF DESCRIPTION OF DRAWINGS

FIG. 1 shows a perspective view of a first embodiment of a mobile audio device in accordance with the present invention.

FIG. 2 shows a planar front view of the mobile audio device of FIG. 1.

FIG. 3 shows a planar back view of the mobile audio device of FIG. 1.

FIG. 4 shows a planar side view of the mobile audio device of FIG. 1.

FIG. 5 shows a planar end view of the mobile audio device of FIG. 1.

FIG. 6 shows an exploded perspective rear view of the mobile audio device of FIG. 1.

FIG. 7 illustrates a schematic of the internal components of the mobile audio device of FIG. 1 in accordance with an embodiment of the present invention.

FIG. 8 shows a planar front view of a second embodiment of a mobile audio device in accordance with the present invention.

FIG. 9 shows a planar back view of the mobile audio device of FIG. 8.

FIG. 10 shows a planar end view of the mobile audio device of FIG. 8.

FIG. 11 shows a planar end view of the mobile audio device of FIG. 8.

FIG. 12 shows the mobile audio device of FIG. 8 with a pre-attached earpiece component extended from the device housing for use.

FIG. 13 illustrates a schematic of the internal components of the mobile audio device of FIG. 8 in accordance with an embodiment of the present invention.

### DETAILED DESCRIPTION OF EMBODIMENTS OF THE INVENTION

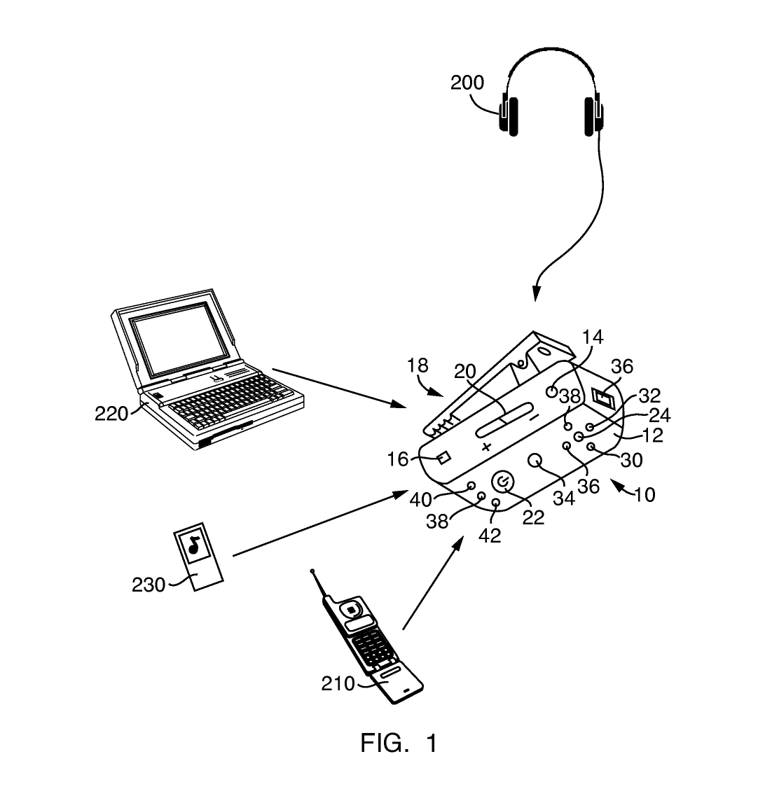

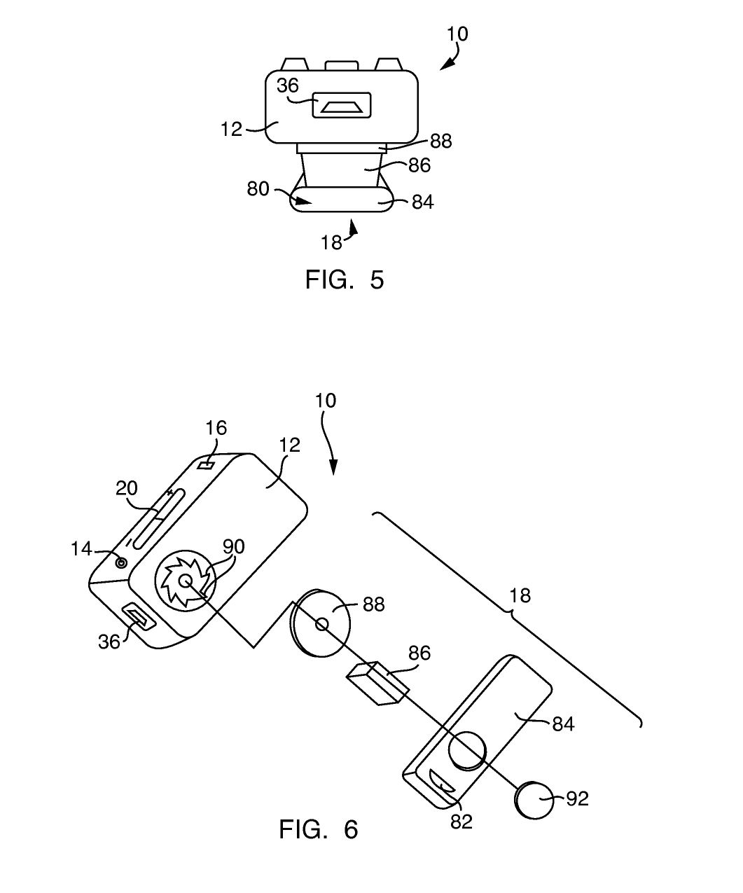

FIGS. 1-6 illustrate an exemplary embodiment of a hands-free mobile audio device in accordance with the present invention. As shown, the mobile audio device, generally designated by reference numeral 10, is used with a set of headphones 200 that wirelessly communicate with electronic devices (e.g., a mobile phone, a laptop computer, and/or a portable music player) via the mobile audio device 10. In this regard, the mobile audio device 10 allows the user to use the headphones 200 in a wireless, hands-free manner, which permits the user to move around to perform other tasks or carry other objects without needing to carry the electronic device(s) with which the mobile audio device 10 is communicating, or without needing to be tethered to the electronic device via the electrical cord of the headphones 200 that are attached to the mobile audio device 10. Significantly, the mobile audio device 10 transforms any headphone, headset or earpiece, including standard headphones commonly provided with portable music players, into a wireless, hands-free device for the transmission of audio signals without needing to modify the headphones in any way.

Referring to FIG. 1, the mobile audio device 10 is wirelessly paired with electronic devices, such as a mobile phone 210, a laptop 220, and a portable music player 230, as shown, typically by any known wireless communications interface, such as a Bluetooth® network, for transmission of audio signals between the electronic devices and the mobile audio device 10. The audio signals received from the electronic devices are transmitted to headphones 200 attached to the mobile audio device 10.

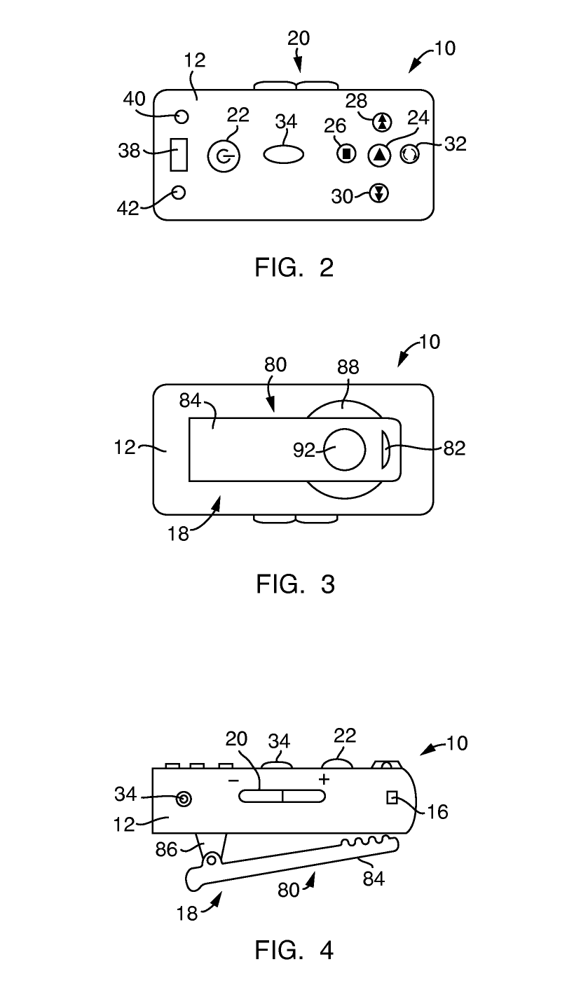

Referring to FIG. 2, the hands-free mobile audio device 10 comprises a housing 12 having an audio output port 14 for transmitting audio signals to at least one earpiece component connected thereto—such as headphones 200 illustrated in FIG. 1—a microphone 16 for receiving audio signals from a user and transmitting said audio signals to an electronic device to which the mobile audio device 10 is connected (such as mobile phone 210) for two-way telephone communication, and a fastener 18 for securing the mobile audio device 10 to the user—e.g., to the user's clothing, bag or briefcase. The housing 12 may further include a variety of user interfaces for controlling operation of the mobile audio device 10, including but not limited to volume controls 20 for adjusting the volume level of the audio output to the headphones 200 upwards or downwards, a power interface 22 for turning the mobile audio device 10 on and off, control buttons for selecting and playing music from an external electronic device, such as a play/pause button 24, a stop button 26, a fast forward button 28 and a rewind button 30, a playlist toggle 32, or a multi-function button 34 capable of controlling interaction with electronic devices (such as a call answer/disconnect button for interaction with a mobile phone 210 to which the mobile audio device 10 is wireless connected during a phone call), including pairing new devices or switching between devices. The housing 12 further includes a power input interface 36, such as micro-USB port, for recharging an internal battery unit disposed within the device housing 12 from an external power source. Though interfaces on the mobile audio device 10 are illustrated and described as buttons or toggle switches, various conventional interfaces, including dials and touchpads, may be used without departing from the spirit and principles of the present invention.

The device housing 12 further includes various indicator means to provide information regarding the operation of the mobile audio device 10. For example, in FIG. 2, the mobile audio device 10 includes a power indicator 38 that indicates that the device 10 is on and operable. As shown, the power indicator 38 is a light that lights up when the device 10 is on. Additional indicator means can be provided to indicate when the device 10 is paired to an electronic device, such as the mobile phone 210, the laptop 220, or the portable music player 230. As shown, a pairing light 40 is provided to indicate when the device 10 is communicating with one or more electronic devices, and thus able to receive and/or transmit audio signals from or to such electronic devices. An additional light 42 can be provided for indicating the charge level of the mobile audio device 101'for example, if lit up, the light 42 indicates that the mobile audio device 10 is sufficiently charged for continued operation. Though the various indicator means provided on the illustrated mobile audio device 10 are shown as lights, various designs and components may be utilized as are known in the art for provided a user with information regarding operation of the mobile audio device, including but not limited to digital or LCD readouts.

In preferred embodiments of the present invention, the mobile audio device 10 acts as a hands-free communication device that enables a user to communicate via a mobile phone where the user speaks using the microphone 16 of the mobile audio device 10 and listens using headphones 200 connected to the mobile audio device 10. The mobile audio device 10 operatively communicates with the mobile phone using a wireless communications interface, such as a Bluetooth® or other short-range wireless network. Operational electronic components and circuitry for using the mobile audio device 10 are maintained within the device housing 12, and generally include a microprocessor or controller (e.g., CPU) for controlling the mobile audio device's electronics, a power supply (e.g., a rechargeable internal battery), memory (e.g., ROM, RAM, flash memory), a circuit board and an appropriate audio circuit for handling audio signals transmitted to and from the mobile audio device 10, components for sending and receiving such audio signals (e.g., antenna, receiver, transmitter, transceiver, etc.), and various input/ output (I/O) support circuitry.

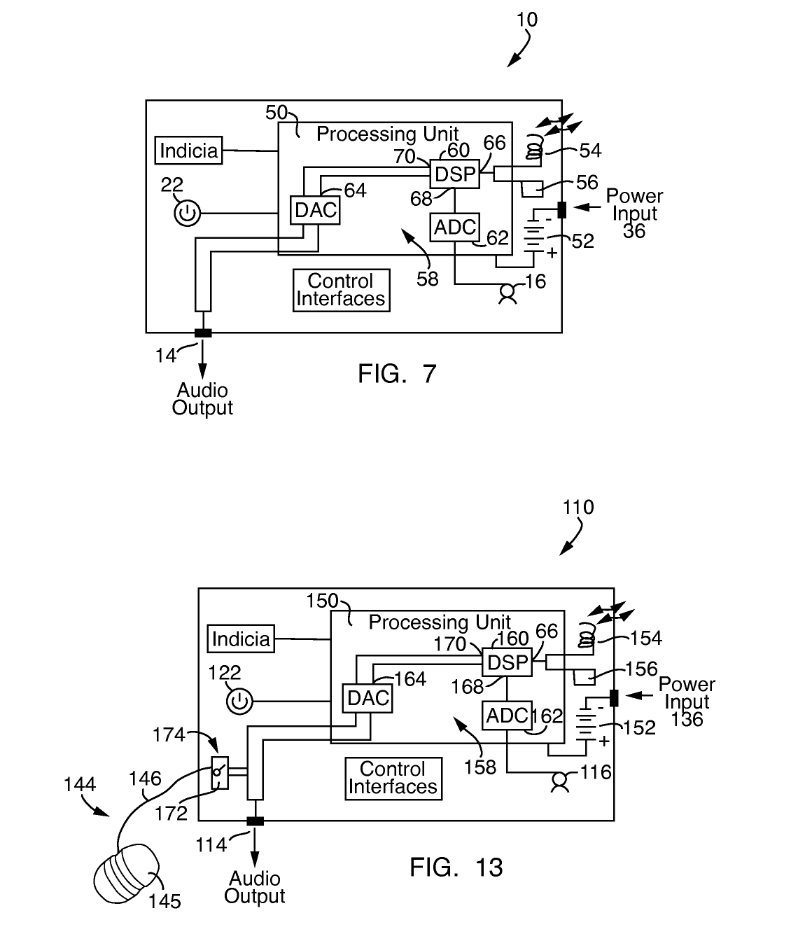

As illustrated in FIG. 7, the mobile audio device 10 includes a controller, including a processing unit 50, configured to execute instructions and to carry out operations associated with the mobile audio device 10. More particularly, the processing unit 50 operatively communicates with an internal rechargeable battery unit 52 disposed within the device housing 12 for keeping track of the capacity level of the battery unit 52. Additionally, the processing unit 50 is in operative communication with the power interface 36, the power indicator 38 and other indicator means, the volume controls 20 and other control buttons, an antenna 54 and a transceiver 56. Still further, the processing unit 50 can be used to store data or provide a conduit means by which data can be exchanged between the mobile audio device 10 and an electronic device to which it is paired.

Referring to FIG. 7, the mobile audio device 10 comprises the rechargeable battery unit 52, which provides power to the internal electronics of the device being controlled by the processing unit 50. The battery unit 52 is disposed within the device housing 12 and is operatively connected with the power input interface 36 for recharging the battery unit 52 when the mobile audio device 10 is connected to an external power source via a power cord, cable or connector (not shown) plugged into the power input interface 36. In preferred embodiments, the rechargeable battery unit 52 is a Lithium-Ion battery.

The mobile audio device 10 further includes an audio circuit 58 that processes audio signals received from an electronic device via the antenna 54 and the wireless transceiver 56 according to known methods, and directs the signals to the audio output port 14, where the signals may be further transmitted to headphones 200 connected thereto for projection to the user. When the mobile audio device 10 is operating as a headset for a mobile phone 210, any audio signals picked up by the microphone 16 are processed by the audio circuit 58 and processing unit 50 according to known methods, and transmitted to a mobile phone 210 to which the mobile audio device 10 is paired via the wireless transceiver 56 and antenna 54. Alternately, the transceiver 56 may be replaced by a receiver and transmitter for exchanging audio signals. Components of antennas, transceivers, receivers and transmitters are generally well known in the technical field, and thus are not discussed in further detail herein.

More particularly, the audio circuit 58 within the mobile audio device 10 may further include a circuit for the antenna 54, a digital signal processor (DSP) 60, an analog/digital converter (ADC) and microphone driver 62, and a digital/analog converter (DAC) and speaker driver 64.

The antenna 54 is linked to a communications terminal 66 of the DSP 60, which communicates through the antenna 54 with an electronic device for transmitting and receiving digital audio and control signals. Herein, “link” indicates a wired or wireless connection supporting control/data communication between two components—such as the mobile audio device 10 and an electronic device to which it is paired. The ADC 62 links the microphone 16 to a digital audio input terminal 68 of the DSP 60, while the DAC 64 links a digital audio output terminal 70 to the audio output interface 14. Various control buttons and interfaces provided on the device housing 12 are also linked through the DSP 60 to the antenna 54, such that operator control signals (e.g., changing a song being played) can be sent from the mobile audio device 10 to the electronic device.

The digital signal processor, analog/digital and digital/analog converters, speaker driver, and microphone driver, may collectively be referred to as an “audio processor”. An audio processor also can include different subcombinations of these components, or of other components, effective to convert between sounds comprehensible to the user and electronic signals comprehensible to an electronic device. For example, the speaker driver or microphone driver may be incorporated respectively into a pre-attached earpiece (such as described below) or the microphone (“audio components”), or one or both of the audio components may be designed such that a driver circuit is not required. As another example, a multiplexer and a buffer memory may be incorporated into the audio processor to permit use of a single ADC for both the microphone and an audio speaker provided with the mobile audio device 10.

Referring to FIGS. 3-6, the mobile audio device 10 preferably includes the fastener 18, such as a spring-biased clip 80, for securing the device 10 in place for use, for example, by attaching it to the user, for example, by clipping to the user's clothing or a bag held proximate the user during use of the mobile audio device 10. Alternatively or additionally, the fastener 18 could comprise an aperture 82 formed in the device housing 12 for holding the device 10 around the user's neck on a lanyard, chain, or the like, thereby securing the device 10 in place.

In a preferred design illustrated in FIG. 3, a rotating clip 80 is provided on the backside of the device housing 12 for securing the device 10 to a user. As shown, the clip 80 comprises an arm 84 pivotally attached to the device housing 12 at a pivot point 86. The clip 80 preferably is spring biased to a closed condition, which is shown in FIG. 4. In use, the clip 80 can be opened by pressing on the arm 84 to move it about the pivot point 86 to an opened condition. Once opened, the clip 80 can be placed over clothing or a strap at a desired location for the mobile audio device 10. When the arm 84 of the clip 80 is released, it will bias to its closed condition and grasp the clothing or strap to secure the device 10 in place. It is desirable for a user to place the mobile audio device 10 in a position that will reduce interference from any cords provided with the headphones 200 attached to the mobile audio device 10. Additionally, it is desirable to place the mobile audio device 10 in a location and orientation that will provide the user with the best access to the audio output port 14 and the microphone 16 provided on the device 10. In this regard, it is preferable and beneficial that the clip 80 is rotatable relative to the device housing 12. As so designed, the orientation of the device housing 12 can be changed even if the device 10 is already clipped to the user so as to place the audio output port 14 and the microphone 16 in the most desirable orientation relative to the user's head. As shown in FIG. 6, the rotatable clip 80 further includes a base 88 that rotates relative to the device housing 12. One or both of the base 88 and the device housing 12 includes a plurality of stops 90 associated with various rotational positions of the clip 80. The stops 90 act to hold or click the clip 80 in a certain orientation and maintain it in such a position so that it won't slip during use. The user can override the stops 90 by applying an extra force to rotate the clip 80 to a new position.

Referring again to FIG. 3, the clip 80 also may include the aperture 82 to receive a lanyard, chain or the like, permitting the mobile audio device 10 to be draped around the user's neck or arm or attached to a bag or briefcase, thereby securing the device 10 in place during use. Still further, the clip 80 or another part of the device housing may include a magnet 92 for securing the device 10 in place for use, for example, by attaching the device 10 to a metallic surface, perhaps the interior of a car or to a bicycle.

Referring back to FIG. 1, the headphones 200 are connected to the mobile audio device 10 by inserting the audio input interface (or plug) of the headphones 200 into the audio output port 14 on the device housing 12. In this regard, the user can use an existing pair of headphones 200, typically used by directly connecting the audio input interface of the headphones 200 into the audio jack of the electronic device. Accordingly, audio signals can be wireless transmitted from an electronic device to the mobile audio device 10, and those audio signals received by the mobile audio device 10 can be transmitted to the headphones 200 via the electrical cord of the headphones 200. Unlike the prior use of the headphones, the user is no longer tethered directly to the electronic device, and has increase mobility and flexibility while still being able to use the headphones as intended. For example, the user can listen to music stored on a personal laptop through the headphones, and move around the room without needing to stay close to the laptop or carry the laptop. The audio signals are transmitted from the laptop to the mobile audio device 10 wirelessly.

Additionally, with the mobile audio device 10 of the present invention, the headphones 200 can now be used for hands-free operation of a mobile phone 210 paired with the mobile audio device 10 by using the microphone 16 on the mobile audio device 10 to transmit audio signals from the user to the mobile phone 210, and by using any pair of headphones 200 attached to the mobile audio device 10, even headphones ordinarily used with a portable music player 230, to listen to the communication through the mobile phone 210.

In accordance with intended operation of the mobile audio device 10 of the present invention, a user can use the same headphones 200 for multiple functions—e.g., use with different electronic devices at the same time. As an example, the user can be listening to music on a portable music player 230 wirelessly connected to the mobile audio device 10, when a call comes into the user's mobile phone 210 that is also paired with the mobile audio device 10. When the user is alerted of an incoming call, for example by an audible signal transmitted by the mobile audio device 10 through the headphones 200 and by a visual signal (e.g., blinking light) on the mobile audio device 10 itself, the user can switch the audio signal sent through the headphones 200 from music transmitted by the portable music player 230 to the incoming phone call—for example, by using a control button on the device housing such as a call answer/disconnect button 34. When the call is finished and the audio signals from the mobile phone 210 stop transmitting—either by the user hanging up on the mobile phone 210 or using the call answer/disconnect button 34 on the mobile audio device 10, or by the person on the other end of the communication ending the call—the mobile audio device 10 will switch back to the audio signals transmitted from the portable music player 230.

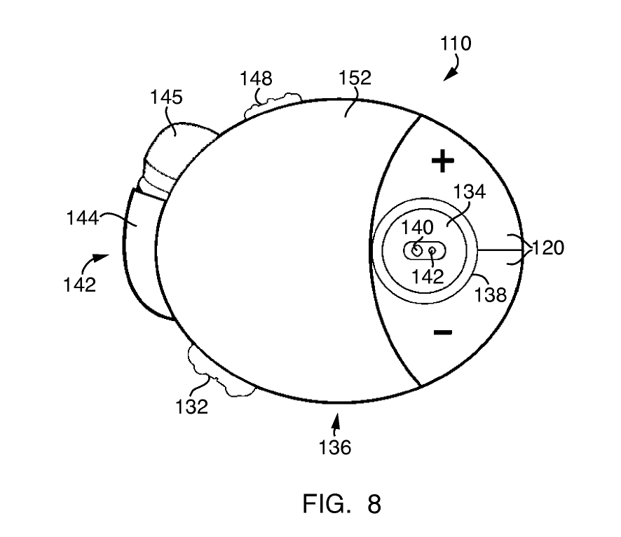

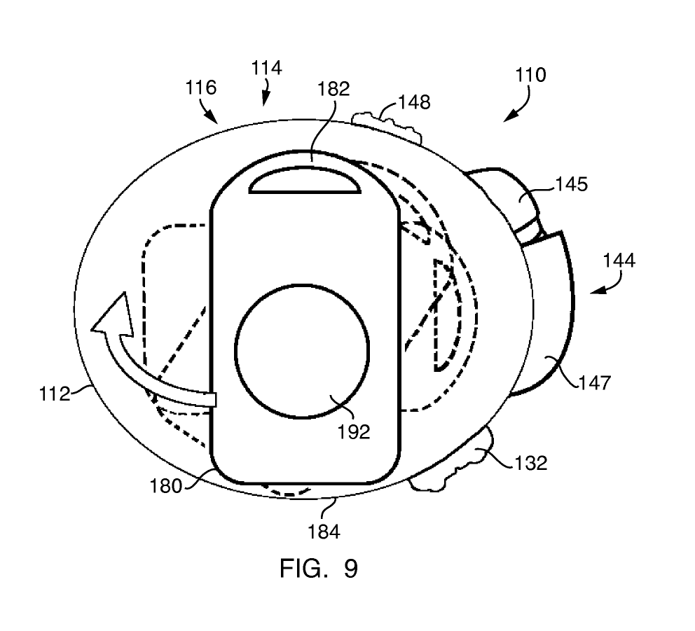

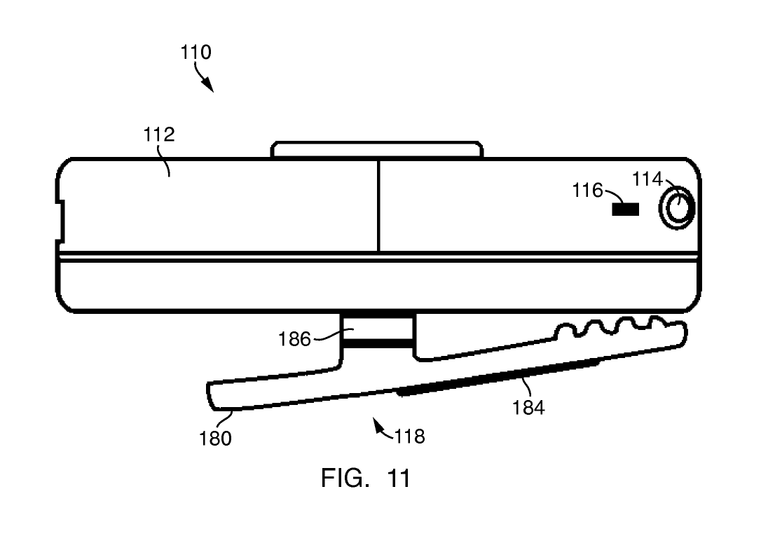

In an alternate embodiment of a mobile audio device in accordance with the present invention, as generally designated as reference numeral 100 in FIGS. 8-13, the device housing 112 includes a pre-attached earpiece 144 for projecting audible signals to a user during use of the mobile audio device 100, preferably as a hands-free communication device that wirelessly communicates with a mobile phone 210, laptop 220, portable music player 230, or other electronic device. As so designed, the user places the earpiece 144 into one ear to receive audio signals from a caller, and uses the microphone 116 on the mobile audio device 100 to send audio signals back via the mobile phone 210. As shown in FIG. 11, the device housing 112 still includes an audio output port 114 allowing the user to add a second earpiece for stereophonic use during a phone call, or whenever the mobile audio device 100 is wirelessly communicating with any other electronic device—e.g., for listening to music from a portable music player 230 or a laptop 220 with which the mobile audio device 100 is wirelessly communicating. Alternatively, the user can use another set of headphones (such as the standard headphones 200 illustrated in FIG. 1) in lieu of the pre-attached earpiece 144 simply by connecting the headphones to the mobile audio device 100 via the audio output port 114.

In the illustrated design, when a second earpiece is attached to the mobile audio device 100 via the audio output port 114, audio signals may be simultaneously transmitted to the pre-attached earpiece 144 and via the audio output port 114. As a result, the user will be able to listen through both the pre-attached earpiece 144 and a second earpiece for stereophonic transmission of audio signals.

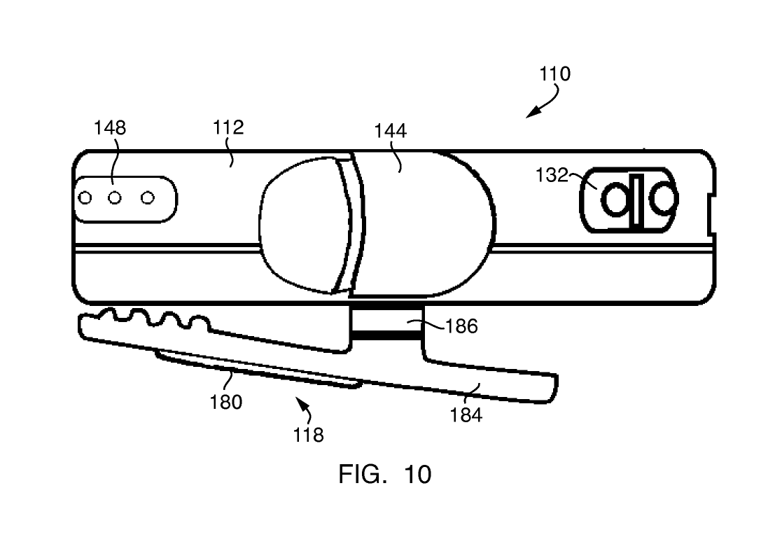

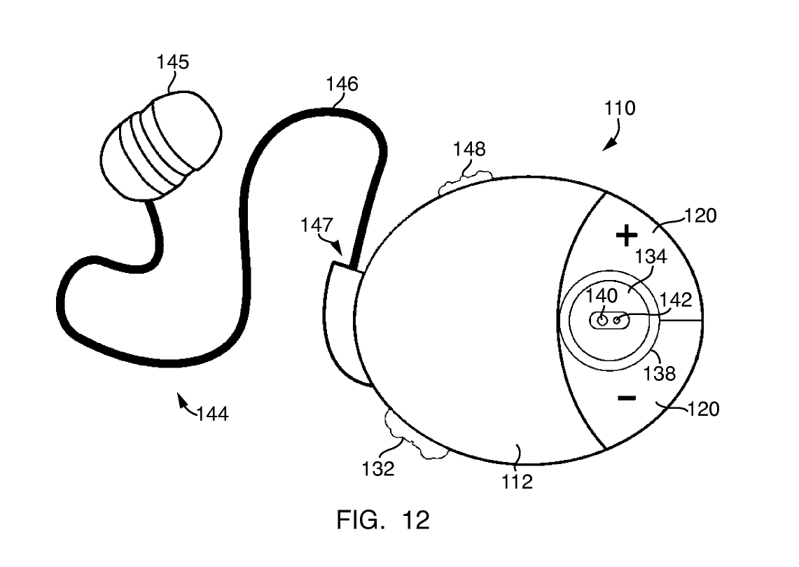

Referring to FIG. 12, an embodiment of the earpiece 144 comprises an earbud 145 housing a speaker (not shown) that is mechanically separable from the device housing 112 on a retractable cord 146 linking the speaker in the earbud 145 to the audio circuit 158 in the device housing 112. The earbud 145 may be retracted, with the cord 146 being stored within the device housing 112, when the earpiece 144 is not in use—e.g., either when the mobile audio device 100 is not being used or is being recharged, or when the user opts to use a separate set of headphones 200 connected to the mobile audio device 100 via the audio output port 114. As shown in FIG. 8, the earbud 145 is housed within a pocket 147 provided on the device housing 112 when it is not is use. The retractable cord 146 is preferably received within the device housing 112. Alternately, a storage cavity may be formed into the device housing 112 for storing the earbud 145 and the cord 146. Various retraction mechanisms for reeling in the cord 146 when not in use are known in the art. As illustrated in FIGS. 8 and 10, a toggle switch 148 is provided on the device housing 112 for retracting the cord 146. Alternatively, the cord 146 may be wrapped around the housing 112 when not in use. With any design of the retractable earpiece 144 in accordance with the present invention, the housing 112 may be clipped to user's clothing, or hung around the user's neck, using a fastener, such as the rotatable clip 180 described above, to secure the mobile audio device 110 during use when connected with an electronic device while the earbud 145 is inserted into the user's ear.

The pre-attached earpiece 144 may also be turned on and off, as desired, during use of the mobile audio device 100. For example, the housing 112 may include a sensor 172 to determine when the earbud 145 and cord 146 have been retracted to a predefined length or position relative to the device housing 112, preferably fully retracted to a non-use position such as shown in FIG. 8. If the sensor 170 detects that the earbud 145 and cord 146 are retracted to the predefined length or position, the sensor 170 will send a signal to the processing unit 150 which will turn off the transmission of audio signals to the pre-attached earpiece 144 via an internal switch 172. Alternately, a positioning sensor can simply detect the location of the earbud portion of the earpiece 144, for example, detecting the positioning of the earbud 145 within its storage pocket 147. In such designs, a user may wish to use a separate set of headphones 200 attached to the mobile audio device 100 via the audio output port 114. When using such separate headphones 200, the user may desire to stop projecting added noise from the pre-attached earpiece 144. Accordingly, so long as the earpiece 144 is positioned where a sensor 170 will detect that audio signals should be stopped, the audio signals will only been transmitted via the audio output port 114.

Still further, the device housing 100 may include an on/off button operatively connected with the processing unit 150, that the user can use to control transmission of audio signals to the pre-attached earpiece 144 without affecting transmission of audio signals via the audio output port 114.

In another alternate embodiment of a mobile audio device in accordance with the present invention, the device may include the pre-attached earpiece component, such as the earbud 145 and retractable cord 146 as shown in FIG. 8, without the additional audio output jack, such that the pre-attached earpiece 144 is used whenever the mobile audio device is wirelessly connected to any electronic device for the transmission of audio signals.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A hands-free mobile audio device for wirelessly connecting an electronic device with a headphone speaker for transmitting audio signals therethrough, said mobile audio device comprising:
a housing;
a wireless interface for connecting with at least one electronic device for transmission of audio signals from the electronic device to the mobile audio device;
at least one audio output port provided on the housing for transmitting audio signals received by the mobile audio device from the electronic device to at least one headphone speaker connected thereto; and
fastening means for securing the housing in place for use.

2. The mobile audio device according to claim 1, wherein said at least one audio output port comprises an interface adapted to receive a complementary input from a separate headphone speaker, wherein connection of the headphone speaker input with the interface on the device housing permits audio signals received by the mobile audio device to be transmitted through the headphone speaker.

3. The mobile audio device according to claim 1, further comprising an earpiece having at least one speaker attached to the housing for transmitting audio signals to the earpiece speaker.

4. The mobile audio device according to claim 3, wherein audio signals are simultaneously transmitted to the earpiece and the audio output port.

5. The mobile audio device according to claim 4, wherein the audio signals transmitted to the earpiece can be turned off without affecting the transmission of signals to the audio output port.

6. The mobile audio device according to claim 3, wherein the earpiece comprises an earbud housing the at least one speaker and being mechanically and operatively connected to the device housing by a cord retractably received in the housing.

7. The mobile audio device according to claim 6, wherein the audio signals transmitted to the earpiece are turned off when the cord is retracted within the device housing to position the earbud at a predefined position relative to the housing.

8. The mobile audio device according to claim 7 further comprising a sensor for detecting the position of the earbud relative to the housing.

9. The mobile audio device according to claim 1, further comprising a microphone provided on the housing for receiving audio signals from a user of the mobile audio device, wherein the mobile audio device transmits received audio signals to an electronic device when said mobile audio device is connected to said electronic device via the wireless interface.

10. The mobile audio device according to claim 1, wherein the fastening means comprises a spring-biased clip.

11. The mobile audio device according to claim 2, wherein the spring-biased clip comprises a rotatable clip that permits the orientation of the housing to be adjusted.

12. The mobile audio device according to claim 1, wherein the fastening means comprises a magnet.

13. A hands-free mobile audio device for wirelessly connecting an electronic device with a headphone speaker for transmitting audio signals therethrough, said mobile audio device comprising:
a housing;
a wireless interface for connecting with at least one electronic device for transmission of audio signals from the electronic device to the mobile audio device;
a first earpiece mechanically and operatively attached to the housing permitting at least monophonic use of the mobile audio device to transmit audio signals received by the mobile audio device from an electronic device with which it is connected via the wireless interface to a speaker provided in the first earpiece; and
an audio output port provided on the housing for transmitting the audio signals received by the mobile audio device from the electronic device to at least one separate second earpiece connected thereto and permitting stereophonic use of the mobile audio device when the separate second earpiece is connected with the audio output port and used simultaneously with the attached first earpiece.

14. The mobile audio device according to claim 13, wherein the audio output port can be used independently of the attached first earpiece when a separate second earpiece having at least one speaker is connected to the mobile audio device via the audio output port.

15. The mobile audio device according to claim 14, wherein audio signals transmitted to the attached first earpiece can be turned off without affecting the transmission of signals to the audio output port.

16. The mobile audio device according to claim 13, wherein the attached first earpiece comprises an earbud housing a speaker and being mechanically and operatively connected to the device housing by a cord retractably received in the housing.

17. The mobile audio device according to claim 16, wherein the audio signals transmitted to the attached first earpiece are turned off when the cord is retracted within the device housing to position the earbud at a predefined position relative to the housing.

18. The mobile audio device according to claim 17 further comprising a sensor for detecting the position of the earbud relative to the housing.

19. The mobile audio device according to claim 13, further comprising a microphone provided on the housing for receiving audio signals from a user of the mobile audio device, wherein the mobile audio device transmits received audio signals to an electronic device when said mobile audio device is connected to said electronic device via the wireless interface.

20. The mobile audio device according to claim 13, further comprising fastening means for securing the housing in place for use.
